(19) United States
(12) Patent Application Publication
(10) Pub. No.: US 2005/0011911 A1
(43) Pub. Date: Jan. 20, 2005

(54) Closure

(76) Inventor: Geoffrey Vaughan, Bedfordshire (GB)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/483,709

(22) PCT Filed: Jul. 9, 2002
(86) PCT No.: PCT/GB02/03169

(30) Foreign Application Priority Data
Jul. 10, 2001 (GB) 0116804.6

(51) Int. Cl. B67D 5/06

(52) U.S. Cl. 222/182; 222/562

(57) ABSTRACT

A closure (1) for a beverage container may have a base cap (2) for securing to the container and a detachable over-cap (3) for protecting a valve member (10) providing an outlet through which a beverage can be dispensed. The over-cap (3) has an array of holes (21) providing airways through the over-cap (3) to prevent choking if the over-cap (3) is accidentally swallowed and lodges in the throat in any orientation. The holes (21) are arranged to permit through flow of air in any orientation of the over-cap (3). The over-cap (3) may also be provided with ribs (14) or channels providing airways to allow flow of air around the outside of the cap (3) if swallowed and lodging in the throat.

The present invention relates to closures for containers such as bottles. More particularly, the invention concerns closures which can be used to dispense the contents of the container, for example a beverage.

Traditionally, beverage containers are provided with screw caps which can be removed to open an outlet through which the beverage can be poured into a glass or similar receptacle when it is desired to consume the beverage. The screw cap is then re-fitted to close and seal the outlet and prevent leakage of any beverage remaining in the container and/or to prevent contamination/deterioration of the beverage.

The outlet permits a fairly high flow of the beverage when open and it is not practical to drink directly from the container. Recently, closures have been developed which include a valve for dispensing the contents of a container to which the closure is attached without removing the closure.

The valve is operable to open an outlet in the closure which the user can place in the mouth to drink the contents directly from the container. The valve is designed to provide a lower flow rate which the user can swallow without spilling the contents. The valve is also operable to close the outlet allowing the user to seal the container when it is desired to save the contents of the container for future consumption.

Providing the container with a closure which permits the contents to be consumed directly from the container by placing part of the closure in the mouth requires high standards of cleanliness to avoid health risks from contamination of the closure.

Accordingly, it is usual for this type of closure to have a cover that fits over the outlet and protects it from contamination when the valve is closed. The cover is removable when it is desired to open the valve to consume the contents of the container and is re-fitted again when the valve is closed.

The cover is a fairly small item and can give rise to a risk of choking if swallowed accidentally. This is a particular danger with children. The present invention is intended to solve this problem and has for its object the provision of a closure with a removable cover for an outlet in the closure which reduces the risk of choking if swallowed.

According to one aspect of the present invention, there is provided a closure for a container wherein the closure has an outlet that is operable to dispense a liquid from a container to which the closure is secured, and a removable cover for the outlet wherein the cover is provided with means forming an airway to prevent choking if the cover is swallowed.

The means forming the airway may be one or more apertures in the cover that allow the flow of air through the cover if it is swallowed and becomes lodged in the throat.

Preferably, the cover has an end wall that overlies the outlet and a skirt depending from the end wall in which the or each aperture is formed. In this way, the end wall prevents contamination of the outlet when the cover is in position, and the or each aperture allows air to flow through the cover if it is swallowed and becomes lodged in the throat.

Advantageously, the or each aperture is arranged to permit airflow through the cover in either of two mutually perpendicular directions. In this way, the risk of choking is avoided whether the cover becomes lodged in an upright or sideways orientation.

Preferably a plurality of apertures are provided spaced apart in a circumferential direction whereby one or more apertures is open in any orientation of the cover. The apertures may be of any size or shape and/or arranged in any pattern capable of providing sufficient airflow to allow comfortable breathing in any orientation of the cover. For example, the cover may be provided with apertures to produce an airflow of at least 8 litres/minute. In one arrangement, eight apertures are provided, uniformly spaced apart in a circumferential direction.

Advantageously, the or each aperture communicates with a recessed portion in the outer surface of the skirt that extends to the end wall. In this way, the aperture is not blocked if the cover becomes lodged in an upright orientation with the skirt contacting the throat. As a result, the aperture remains open and air can flow through the cover in both directions via the aperture and recessed portion.

Alternatively or additionally to airflow through the cover, the cover may be provided with one or more external formations that allow the flow of air around the outside of the cover if it is swallowed and becomes lodged in the throat.

Thus, the or each external formation may comprise a groove in the skirt that extends from the end wall to the open end of the cover providing a channel in the outer surface of the skirt so that air can flow past the cover in both directions. The or each groove may include the recessed portion communicating with an aperture in the skirt.

Alternatively, the or each external formation may comprise a rib that projects outwardly from the skirt to space the skirt from a surface contacted by the rib. In this way, an air-way is formed either side of the rib so that air can flow past the cover in both directions.

Advantageously, multiple air-ways are formed extending axially from the end wall to the other, open end of the cover by a plurality of ribs projecting outwardly from the skirt and spaced apart in a circumferential direction.

In one arrangement, one aperture is provided between each pair of adjacent ribs. In another arrangement, one aperture is provided between alternate pairs of adjacent ribs. Other arrangements of apertures and ribs that may be employed to provide a suitable flow of air if the cover is swallowed and becomes lodged in the throat will be apparent to those skilled in the art.

Advantageously, the closure comprises a base cap provided with the outlet for securing to the container and the cover comprises an over-cap releasably secured to the base cap to cover the outlet.

Preferably, a lock ring is provided for initially securing the over-cap to the base cap and the over-cap is separable from the lock ring when the over-cap is first removed to consume the contents of the container. In this way, the integrity of the closure can be visually checked by the retailer/purchaser of a container to which the closure is secured.

The over-cap may be secured to the lock ring by frangible webs that rupture when the over-cap is rotated relative to the lock ring. For example, the webs may be spaced apart around the open end of the over-cap, and the lock ring and base cap may have interengageable formations to prevent rotation of the lock ring relative to the base cap.

Advantageously, the over-cap fits over the outlet in the base cap and the base cap has a stepped portion on which the over-cap is an interference fit to secure the over-cap when separated from the lock ring. In this way, the over-cap can be removed and re-fitted as desired.

The interference fit may be a simple friction fit. Alternatively, the interference fit may be a snap fit to retain positively the over-cap and provide a tactile indication to the user that the over-cap has been correctly secured. For example, the over-cap may be provided with an internal flange or similar formation arranged to snap engage a groove in the stepped portion.

Preferably, the base cap has an internal screw thread co-operable with an external screw thread on a neck of the container for securing the closure to the container and allowing the closure to be removed if it is desired to empty or fill the container through an opening defined by the neck.

Advantageously, a lock ring is provided for initially securing the base cap to the container and the base cap is separable from the lock ring when the base cap is first removed from the container. In this way, the integrity of the closure can be visually checked by the retailer/purchaser of a container to which the closure is secured.

The base cap may be secured to the lock ring by frangible webs that rupture when the base cap is rotated relative to the lock ring. For example, the webs may be spaced apart around the open end of the base cap, and the lock ring and container may have interengageable formations to prevent rotation of the lock ring relative to the container.

Preferably, the outlet is provided in a head of a valve member movable between a first position in which the outlet is closed and a secured position in which the outlet is open to allow the contents of the container to be consumed through the outlet with the base cap attached to the container.

Advantageously, the apertures in the skirt are spaced from the end wall so that, when the over-cap is fitted over the valve member, the apertures are positioned below the head of the valve member. In this way, the outlet is protected from contamination by any fluid entering the over-cap via the apertures in the skirt.

Preferably, the valve member prevents the over-cap being attached to the base cap when the outlet is open. In this way, the outlet must be closed both when initially assembling the closure and, in use, when re-fitting the over-cap to cover the outlet. As a result, the risk of spillage or leakage occurring by fitting the over-cap with the outlet open is avoided.

Advantageously, the base cap and over-cap are mouldings of food-grade plastics, for example low density or high density polyethylene or polypropylene. The over-cap is preferably made of clear plastics so that the outlet is visible through the over-cap and any contamination of the outlet can be seen. This is not essential, however, and the over-cap may be made of coloured plastics. Likewise, the base-cap may be made of a clear or coloured plastics that may match or contrast with the over-cap.

According to a second aspect of the present invention, there is provided an over-cap for removably covering an outlet in a container for liquids, especially a beverage container, wherein the over-cap is constructed to form an air-way to reduce the risk of choking if swallowed.

Preferably, the over-cap covers the outlet to protect the outlet from contamination and is removable when it is desired to consume the contents of the container.

Advantageously, the outlet is formed in a base cap for securing to the container and the over-cap fits on the base cap to cover the outlet. The base cap and over-cap may be initially secured together for assembly of a closure for fitting to the container with the over-cap being detachable from the base cap to expose the outlet when it is desired to consume the contents of the container. The base cap is preferably releasably secured to the container so that the container can be emptied and/or filled with the closure removed.

These and other features, benefits and advantages of the invention will be apparent from the description later herein of exemplary embodiments.

The invention will now be described in more detail by way of example only, with reference to the accompanying drawings wherein:

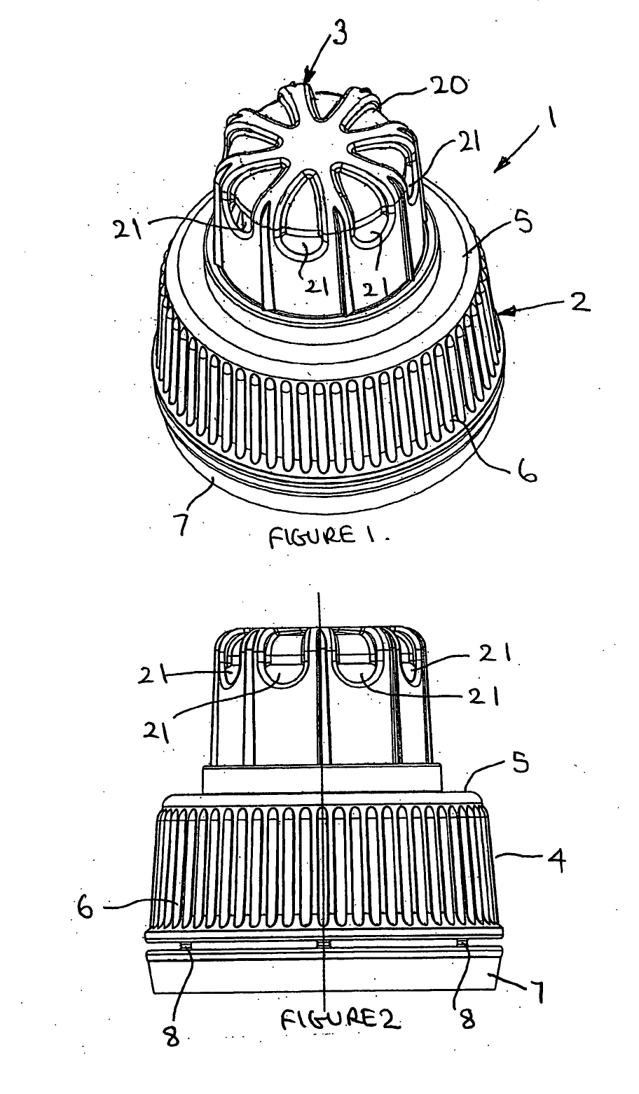

FIG. 1 is a perspective view of a closure embodying the present invention;

FIG. 2 is a side view of the closure shown in FIG. 1;

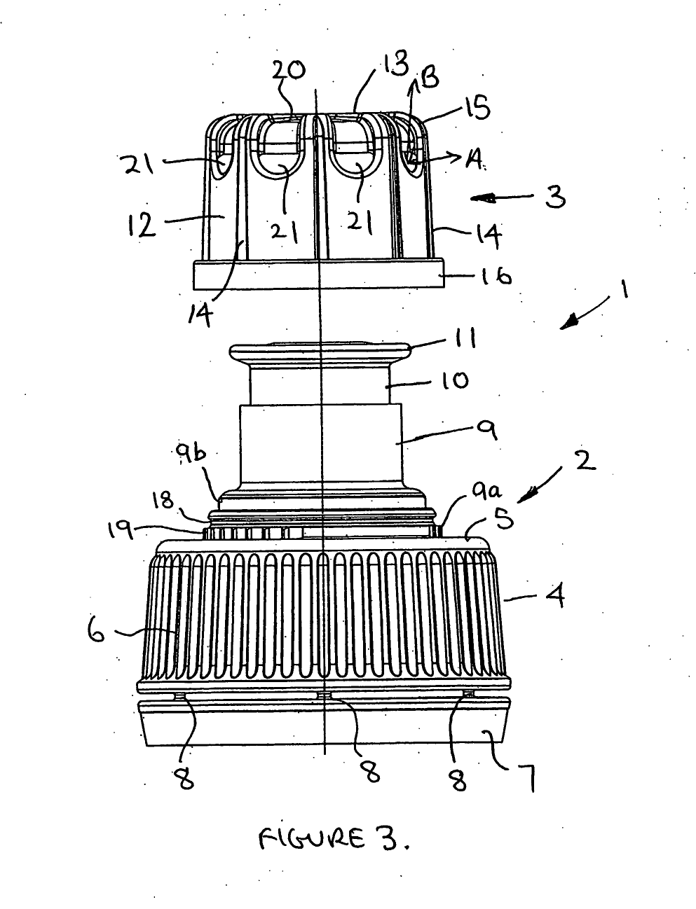

FIG. 3 is an exploded side view of the base cap and over-cap of the closure shown in FIG. 1 with the valve member in the open position;

FIG. 4 is a side view of the base cap shown in FIG. 3 with the valve member in the closed position;

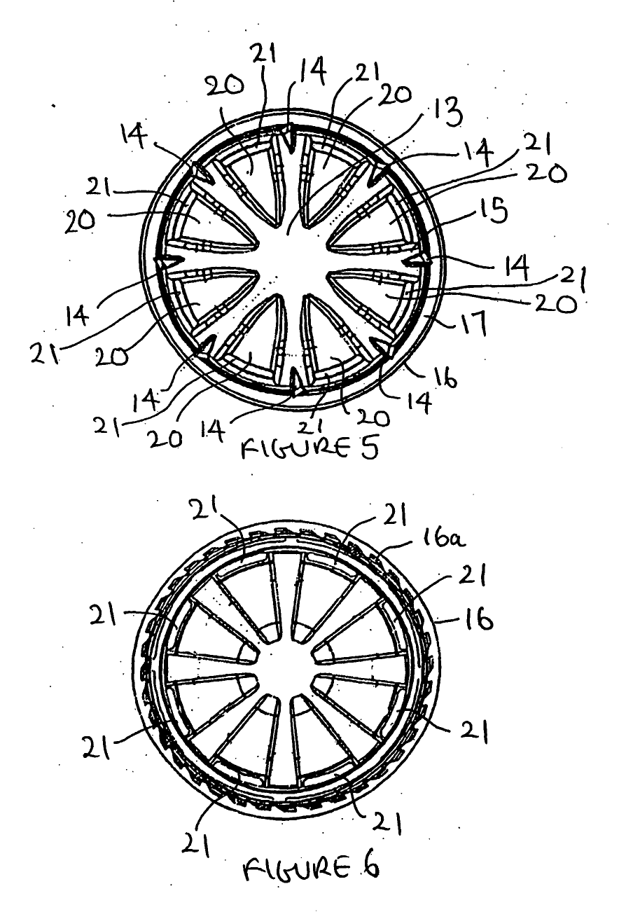

FIG. 5 is a plan view of the over-cap shown in FIG. 3;

FIG. 6 is an underneath plan view of the over-cap shown in FIG. 3;

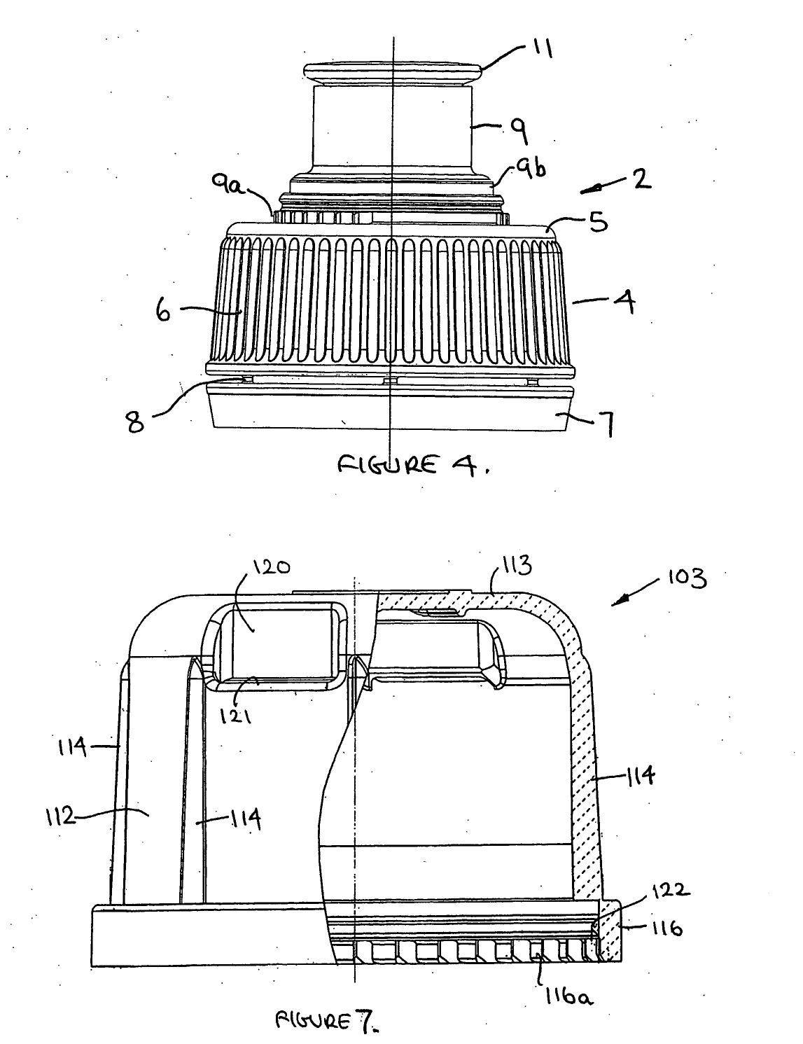

FIG. 7 is a side view to an enlarged scale and partly in section, of an alternative over-cap for use with the base cap of the closure shown in FIGS. 1 to 3:

FIG. 8 is a side view of the over-cap shown in FIG. 7;

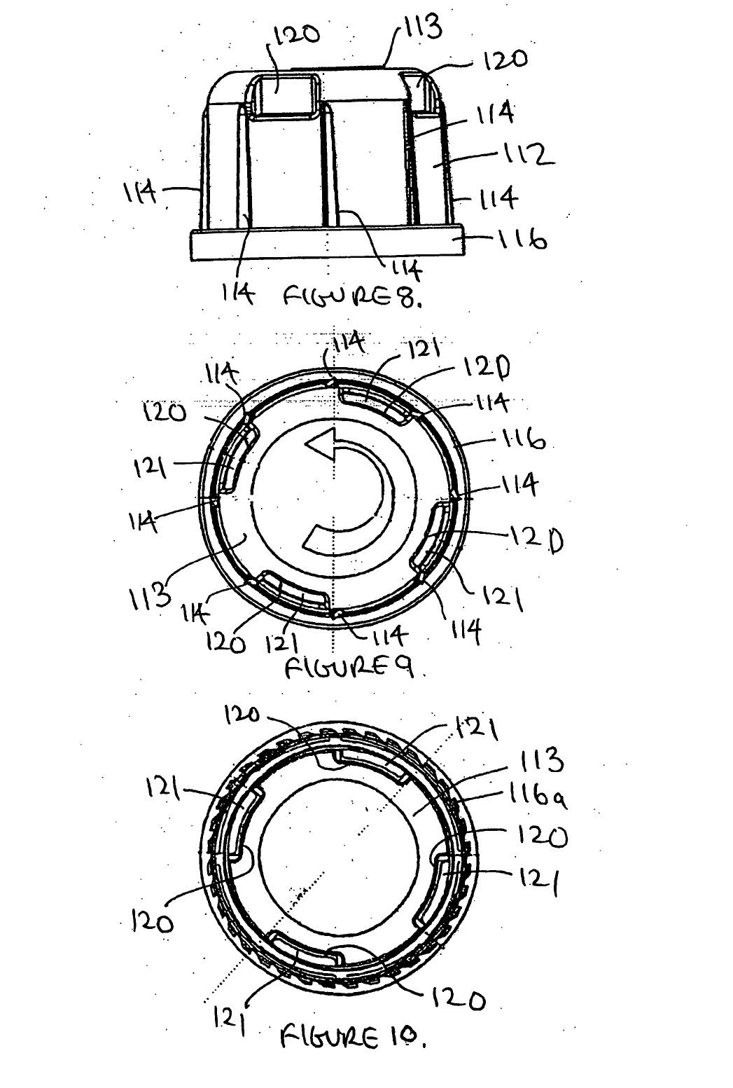

FIG. 9 is a plan view of the over-cap shown in FIG. 7; and

FIG. 10 is an underneath plan view of the over-cap shown in FIG. 7.

Referring first to FIGS. 1 to 6 of the accompanying drawings, a closure 1 for attaching to a beverage container such as a bottle (not shown) to close an outlet in the container is depicted.

The closure 1 comprises a base cap 2 and an over-cap 3. The base cap 2 and over-cap 3 are both mouldings of a food grade plastics such as low density or high density polyethylene or polypropylene.

In this embodiment, the base cap 2 is made of coloured plastics and the over-cap 3 is made of clear plastics. This is not essential however and the base cap 2 and over-cap 3 may be made of matching or contrasting clear or coloured plastics.

The base cap 2 has a cylindrical skirt 4 depending from an end wall 5. The skirt 4 is formed with an internal screw thread (not shown) engageable with a complementary external screw thread (not shown) on a neck of the container to which the closure 1 is to be secured.

The skirt 4 has finger grips in the form of circumferentially spaced axial serrations 6 to facilitate rotation of the base cap 2 for securing the closure 1 to the container.

The base cap 2 is provided with a annular lock ring 7 secured by webs 8 to the open end of the skirt 4 remote from the end wall 5. The lock ring 7 is moulded integrally with the base cap 2 from the same plastics material.

The lock ring 7 is formed with internal teeth (not shown) that ride over annular ribs (not shown) on the neck of the container when the base cap 2 is rotated in a direction to secure the closure 1 to the container.

The teeth engage behind the ribs and resist removal of the closure 1 by rotating the base cap 2 in the opposite direction until the webs 8 rupture separating the base cap 2 from the lock ring 7. As a result, the closure 1 can be removed from the container leaving the lock ring 7 in place on the neck of the container and can be re-secured if desired.

The lock ring 7 provides a visual indication of the condition of the closure 1 and in particular whether the closure 1 has been removed from the container after fitting to the container. In this way, consumers and retailers can readily identify containers where the contents may have been tampered with by removal and re-fitting of the closure 1.

The base cap 2 also has a tubular upstand 9 extending from the end wall 5 in which a valve member 10 is slidably mounted. The valve member 10 has an enlarged annular head 11 formed with a central hole (not shown). The hole forms an outlet through which the contents of the container can be dispensed with the base cap 2 secured to the container.

The upstand 9 is formed with an internal plug (not shown) that is )-received in the hole to close the outlet in a first end position of the valve member 10 (FIG. 4). The valve member 10 is manually slidable between the first end position and a second end position (FIG. 3) in which the plug is withdrawn from the hole to open the outlet.

The upstand 9 and valve member 10 are shaped so that the contents of the container can be consumed directly by placing the outlet in the mouth of the user with the valve member 10 in the open position. In this way the user does not have to pour the contents of the container into a cup or similar receptacle for consumption.

The hole and plug are shaped to provide a low rate of flow which allows the user to consume the contents of the container easily when the outlet is positioned in the mouth. A higher rate of flow can be obtained, for example when dispensing the contents of the container into a cup or similar receptacle, by removing the closure 1 and pouring the contents through the outlet formed by the neck of the container.

As will now be appreciated, the closure 1 enables the contents of the container to which it is secured to be dispensed either through the outlet in the head 11 of the valve member 10 with the base cap 2 attached to the container or through the outlet in the neck of the container by removing the closure 1. The end user can choose the method of dispense according to circumstances and personal preference.

It will also be readily apparent that drinking directly from the outlet in the head 11 of the valve member 10 presents a potential hygiene risk to the end user if the head 11 and upstand 9 are contaminated in any way, for example by dirt. To reduce this risk, the closure 1 includes over-cap 3 which covers the outlet in the head 11 and is removable when it is desired to consume the contents of the container.

The over-cap 3 has a cylindrical skirt 12 depending from an end wall 13. The skirt 12 is formed on the outer surface with eight axially extending ribs 14 uniformly spaced in a circumferential direction. Each rib 14 extends the full height of the skirt 12 from the open end to a shoulder region 15 connecting the skirt 12 to end wall 13.

The over-cap 3 is provided with an annular lock ring 16 having an internal flange 17 at one end attached to the open end of the over-cap 3 via the ribs 14. The lock ring 16 is moulded integrally with the over-cap 3 from the same plastics material.

The lock ring 16 is a push fit on a base portion 9a of the upstand 9 to cover the upstand 9 and valve member 10. An internal annular lip (not shown) snap engages an annular groove 18 in the base portion 9a to secure the over-cap 3 to the base cap 2.

The lock ring 16 is further provided with internal teeth 16a that engage teeth 19 on the base portion 9a to prevent rotation of the lock ring 16 relative to the base cap 2.

In this way, twisting the over-cap 3 in either direction will cause the connections between the ribs 14 and the flange 17 to rupture allowing the over-cap 3 to be detached from the base cap 2 when it is desired to open the outlet in the head 11 of the valve member 10 to consume the liquid in the container.

The open end of the over-cap 3 is an interference friction fit on a stepped portion 9b of the upstand 9 such that the over-cap 3 can be re-fitted when the outlet in the head 11 is closed so as to cover the upstand 9 and valve member 10.

In this way, the over-cap 3 provides protection against contamination of the upstand 9 and valve member 10 both when the closure 1 is initially fitted to the container and, in use, when the outlet in the head 11 is closed.

The length of the skirt 12 is such that, if the over-cap 3 is re-positioned on the upstand 9 with the valve member 10 in the open position, the skirt 12 is clear of the stepped portion 9b. As a result, the over-cap 3 cannot be re-secured and is a loose fit on the head 11 of the valve member 10.

In this way, a visual and tactile indication is provided to the user that the valve member 10 is in the open position and that the valve member 10 should be moved to the closed position in order to secure the over-cap 3.

As a result, the risk of the user leaving the closure 1 with the outlet in the head 11 open is reduced.

The over-cap 3 is a relatively small, lightweight item which if swallowed accidentally or inadvertently could become lodged in the throat causing a blockage that could lead to choking, especially in the case of young children.

Accidental or inadvertent swallowing is a particular problem if users remove the over-cap 3 and move the valve member 10 to the open position with their teeth to avoid contaminating the over-cap 3 and, more importantly the head 11 of the valve member 10 with dirty hands.

The over-cap 3 of the present invention is constructed to reduce the risk of choking if the over-cap 3 is swallowed or becomes lodged in the throat.

To this end, the over-cap 3 is formed in the outer surface of the end wall 13 with eight circumferentially spaced recessed portions 20 of triangular shape in plan view. The recessed portions 20 extend through the shoulder region 15 between adjacent pairs of ribs 14 and terminate in apertures 21 in the skirt 12 spaced from the end wall 13.

The apertures 21 are constructed and arranged to provide substantially unrestricted flow of air between the interior and exterior of the over-cap 3 in two mutually perpendicular directions.

Thus, as shown in FIGS. 1 to 3, the apertures 21 form D-shaped openings in side view allowing free flow of air in a direction transverse to the longitudinal axis of the over-cap 3 as indicated by the arrow A in FIG. 1.

Furthermore, as shown in FIGS. 5 and 6, the apertures 21 form rectangular shaped openings in plan view allowing free flow of air in a direction parallel to the longitudinal axis of the over-cap 3 as indicated by the arrow B in FIG. 1.

With this arrangement of the apertures 21 air can flow freely through the over-cap 3 to prevent choking if the over-cap 3 is swallowed and sticks in the throat in both upright (normal or inverted) and sideways orientations.

More particularly, in the upright (normal and inverted) orientation, the rectangular shaped openings are clear and allow flow of air through the over-cap 3 to prevent choking. In the sideways orientation, D-shaped openings on opposite sides of the over-cap 3 are clear and allow flow of air through the over-cap 3 to prevent choking.

In addition to the airways through the over-cap 3 provided by the apertures 21, the external ribs 14 act as spacers for the skirt 12 if the over-cap 3 becomes lodged in the throat in an upright (normal or inverted) orientation. As a result, air-ways are formed on each side of the ribs 14 that extend between opposite ends of the over-cap 3 and allow air to flow in both directions around the outside of the over-cap 3.

In a modification (not shown), the triangular shaped recessed portions 20 in the end wall 13 may be interconnected so as to provide a path for air to flow around the cap 3 if it becomes lodged in the throat in a sideways orientation.

In another modification (not shown), the recessed portions 20 may extend from the end wall 13 to the other end of the over-cap 3 to provide channels for air to flow in both directions around the outside of the over-cap 3. Such channels may be provided in addition to or in place of the ribs 14.

In yet another modification (not shown), the recessed portions 20 may be an interference fit on the head 11 of the valve member 10 to secure releasably the over-cap 3 to the base cap 2. Such interference fit may be used when re-fitting the over-cap 3 after the initial location provided by the lock ring 16 has been ruptured. The interference fit may be a simple friction fit. Alternatively, a snap fit may be employed to give a positive tactile indication to the user when the over-cap 3 has been correctly secured.

As will now be appreciated the invented over-cap 3 covers the outlet in the valve head 11 when fitted to the base part 2 to prevent contamination and reduces the risk of choking if swallowed when removed from the base part 2.

Thus, when the over-cap 3 is fitted to the base part 2, the apertures 21 open below the underside of the valve head 11 to protect the outlet. In addition, when the over-cap 3 is removed from the base part 2, the apertures 21 allow air to flow in both directions through the over-cap 3 in either an upright or sideways orientation. Moreover, ribs 14 air to flow around the outside of the over-cap 3.

Referring now to FIGS. 7 to 10, an alternative over-cap for use with the base cap of the previous embodiment is shown in which like reference numbers in the series 100 are used to indicate parts corresponding to the previous embodiment.

In this modification, the over-cap 103 has a skirt 112 formed with four apertures 121 uniformly spaced apart in a circumferential direction. Each aperture 121 communicates with a recessed portion 120 that extends to the shoulder region 115 so that air can flow in both directions through the over-cap 3 as described previously.

The apertures 121 are provided between alternate pairs of adjacent ribs 114 that act to space the outer surface of the skirt 112 from a surface contacted by the ribs 114. In this way, the ribs 114 create a path allowing air to flow in both directions around the outside of the over-cap 103 as described previously.

In other respects, the construction and operation of this alternative version of the over-cap 103 is similar to that of the previous embodiment and will be readily understood from the description already provided. The internal lip for securing the lock ring 116 to the base cap can be seen in FIG. 7 and is indicated by reference numeral 122.

It will be understood that the above-described embodiments are intended to illustrate the application of the invented closure and that features of the embodiments may be used separately or in combination with any other feature of the same or different embodiments to produce a closure with an over-cap that reduces the risk of choking if swallowed.

Moreover, while the specific materials and/or construction of the closures )e described and illustrated are believed to represent the best means currently known to the applicant, it will be appreciated that the invention is not limited thereto and that various modifications and improvements can be made without departing from the principle or concept of the invention to reduce the risk of choking if the over-cap is swallowed by constructing the over-cap to provide a path for air to flow through or around the over-cap in both directions irrespective of the orientation in which the over-cap may become lodged in the throat.

For example, the number, position or shape of the apertures and/or external ribs may be varied from that shown to provide any desired airflow characteristics. Generally an airflow of at least 8 litres/minute is suitable but we may wish to provide a higher airflow by appropriate design of the apertures and/or external ribs. The apertures and/or external ribs may be replaced by any other suitable formations that allow flow of air through or around the over-cap in both directions.

1. A closure for a beverage container, wherein the closure has an outlet that is operable to dispense a liquid from a container to which the closure is secured, and a removable cover for the outlet, the cover has an end wall that overlies the outlet and a skirt depending from the end wall, and is provided with at least one aperture wherein the aperture is provided in the skirt spaced from the end wall such that the cover protects the outlet from contamination and the aperture forms an airway to prevent choking if the cover is swallowed.

2. A closure according to claim 1 wherein the aperture is arranged to permit airflow through the cover in either of two mutually perpendicular directions.

3. A closure according to claim 1 wherein a plurality of apertures are provided spaced apart in a circumferential direction whereby one or more apertures is open in any orientation of the cover.

4. A closure according to claim 3 wherein the apertures produce an airflow of at least 8 litres/minute.

5. A closure according to claim 3 wherein eight apertures are provided, uniformly spaced apart in the circumferential direction.

6. A closure according to claim 1 wherein the aperture communicates with a recessed portion in the outer surface of the skirt that extends to the end wall.

7. A closure according to claim 1 wherein the cover comprises e at least one external formation that allows the flow of air around the outside of the cover if it is swallowed and becomes lodged in the throat.

8. A closure according to claim 7 wherein the formation comprises a groove in the skirt that extends from the end wall to the open end of the cover providing a channel in the outer surface of the skirt so that air can flow past the cover in both directions.

9. A closure according to claim 8 wherein the aperture communicates with a recessed portion in the outer surface of the skirt that extends to the end wall and the groove includes the recessed portion communicating with an aperture in the skirt.

10. A closure according to claim 9 wherein the external formation comprises a rib that projects outwardly from the skirt to space the skirt from a surface contacted by the rib providing air-ways on either side of the rib so that air can flow past the cover in both directions.

11. A closure according to claim 10 wherein multiple air-ways are formed extending axially from the end wall to the other, open end of the cover by a plurality of ribs projecting outwardly from the skirt and spaced apart in a circumferential direction.

12. A closure according to claim 10 wherein one aperture is provided between each pair of adjacent ribs.

13. A closure according to claim 11 wherein one aperture is provided between alternate pairs of adjacent ribs.

14. A closure according to claim 1 wherein the closure comprises a base cap provided with the outlet for securing to the container and the cover comprises an over-cap releasably secured to the base cap to cover the outlet.

15. A closure according to claim 14 wherein a lock ring is provided for initially securing the over-cap to the base cap and the over-cap is separable from the lock ring when the over-cap is first removed to consume the contents of the container.

16. A closure according to claim 15 wherein the over-cap is secured to the lock ring by frangible webs that rupture when the over-cap is rotated relative to the lock ring.

17. A closure according to claim 16 wherein the webs are spaced apart around the open end of the over-cap, and the lock ring and base cap have interengageable formations to prevent rotation of the lock ring relative to the base cap.

18. A closure according to claim 17 wherein the over-cap fits over the outlet in the base cap and the base cap has a stepped portion on which the over-cap is an interference fit to secure the over-cap when separated from the lock ring.

19. A closure according to claim 18 wherein the interference fit is a simple friction fit.

20. A closure according to claim 18 wherein the interference fit is a snap fit to retain positively the over-cap and provide a tactile indication to the user that the over-cap has been correctly secured.

21. A closure according to claim 20 wherein the over-cap is provided with an internal formation arranged to snap engage a groove in the stepped portion.

22. A closure according to claim 14 wherein the base cap has an internal screw thread co-operable with an external screw thread on a neck of the container for securing the closure to the container and allowing the closure to be removed if it is desired to empty or fill the container through an opening defined by the neck.

23. A closure according to claim 22 wherein a lock ring is provided for initially securing the base cap to the container and the base cap is separable from the lock ring when the base cap is first removed from the container.

24. A closure according to claim 23 wherein the base cap is secured to the lock ring by frangible webs that rupture when the base cap is rotated relative to the lock ring.

25. A closure according to claim 24 wherein the webs are spaced apart around the open end of the base cap, and the lock ring and container have interengageable formations to prevent rotation of the lock ring relative to the container.

26. A closure according to claim 14 wherein the outlet is provided in a head of a valve member movable between a first position in which the outlet is closed and a second position in which the outlet is open to allow the contents of the container to be consumed through the outlet with the base cap attached to the container.

27. A closure according to claim 26 wherein the aperture apertures in the skirt is spaced from the end wall so that, when the over-cap is fitted over the valve member, the aperture opens below the head of the valve member.

28. A closure according to claim 26 wherein the valve member prevents the over-cap being attached to the base cap when the outlet is open.

29. A closure according to claim 26, wherein the valve member is slidably mounted in a tubular upstand.

30. A closure according to claim 14 wherein the base cap and over-cap are mouldings of food-grade plastics, for example low density or high density polyethylene or polypropylene.

31. A closure according to claim 30 wherein the over-cap is made of clear plastics.

32. A closure according to claim 1 in which the aperture is D-Shaped in side view.

33. A closure according to claim 1 in which the aperture is rectangular shaped in plan view.

34. An over-cap for removably covering an outlet in a beverage container, wherein the over-cap has an end wall and a skirt depending therefrom, and is provided with at least one aperture wherein the aperture is provided in the skirt spaced from the end wall such that the cover protects the outlet from contamination and the aperture forms an airway to prevent choking if the cover is swallowed.

35. An over-cap according to claim 34 wherein the over-cap covers the outlet to protect the outlet from contamination and is removable when it is desired to consume the contents of the container.

36. An over-cap according to claim 34 wherein the outlet is formed in a base cap for securing to the container and the over-cap fits on the base cap to cover the outlet.

37. An over-cap according to claim 36 wherein the base cap and over-cap are initially secured together for assembly of a closure for fitting to the container with the over-cap being detachable from the base cap to expose the outlet when it is desired to consume the contents of the container.

38. An over-cap according to claim 37 wherein the base cap is releasably secured to the container so that the container can be emptied and/or filled with the closure removed.
